(19) United States
(12) Patent Application Publication
(10) Pub. No.: US 2022/0279241 A1
(43) Pub. Date: Sep. 1, 2022

(54) METHOD AND DEVICE FOR RECOGNIZING IMAGES

(71) Applicant: BEIJING DAJIA INTERNET INFORMATION TECHNOLOGY CO., LTD., Beijing (CN)

(72) Inventors: Xuemei SHI, Beijing (CN); Qiangqiang XU, Beijing (CN); Hao YANG, Beijing (CN)

(21) Appl. No.: 17/746,842

(22) Filed: May 17, 2022

Related U.S. Application Data
(63) Continuation of application No. PCT/CN2021/073150, filed on Jan. 21, 2021.

(30) Foreign Application Priority Data
Jan. 21, 2020 (CN) 202010070867.X

(51) Int. Cl. H04N 21/44; G06V 10/10; G06V 10/40; G06T 7/73; G06V 10/22; G06T 7/11; G06V 20/40; G06T 3/40; H04N 21/2187; H04N 21/81

(52) U.S. Cl. CPC H04N 21/44008; G06V 10/16; G06V 10/40; G06T 7/73; G06V 10/22; G06T 7/11; G06V 20/46; G06T 3/4038; H04N 21/2187; H04N 21/8146; G06T 2207/20021; G06T 2207/10016

(57) ABSTRACT

A method for recognizing images is provided. The method includes: acquiring a plurality of to-be-recognized images, acquiring a target image by stitching the plurality of to-be-recognized images, acquiring a plurality of first key points of the target image by inputting the target image into an image recognition model, and determining, based on the plurality of first key points, second key points of each of the to-be-recognized images.

### CROSS-REFERENCE TO RELATED APPLICATION

This application is a continuation application of International Application No. PCT/CN2021/073150, filed on Jan. 21, 2021, which claims the priority of Chinese Application No. 202010070867.X, filed on Jan. 21, 2020, both of which are incorporated by reference herein.

### TECHNICAL FIELD

The present disclosure relates to the field of video technologies, and in particular, to a method and a device for recognizing images.

### BACKGROUND

At present, with the development of video technologies, more and more users perform video communication by terminals such as mobile phones or desktop computers. The video communication can be widely applied in application scenarios such as video calls, video conferences, and video live-streaming. Usually, in the above application scenarios, the user can shoot by a local terminal and play the video shot by the local terminal, and the local terminal can also play the video shot by another terminal, such that the user can view real-time videos of both sides by the local terminal.

Generally, in the above application scenarios, the user can perform special-effect processing on video images. For example, in video live-streaming, the user put animated stickers in the video images of both sides.

### SUMMARY

The present disclosure provides a method and a device for recognizing images. The technical solution of the present disclosure is as follows.

According to some embodiments of the present disclosure, a method for recognizing images is provided. The method is applicable to a computer device and includes:

acquiring a plurality of to-be-recognized images;

acquiring a target image by stitching the plurality of to-be-recognized images;

acquiring a plurality of first key points of the target image by inputting the target mage into an image recognition model; and

determining, based on the plurality of first key points, second key points of each of the to-be-recognized images.

According to some embodiments of the present disclosure, a method for video live-streaming is provided. The method is applicable to a computer device and includes:

acquiring a live video stream of a first account and a live video stream of a second account;

extracting a first to-be-recognized image from the live video stream of the first account and a second to-be-recognized image from the live video stream of the second account;

acquiring a target image by stitching the first to-be-recognized image and the second to-be-recognized image;

acquiring a plurality of first key points of the target image by inputting the target image into an image recognition model;

determining, based on the plurality of first key points, second key points of the first to-be-recognized image and the second to-be-recognized image;

acquiring a first special-effect image by adding, based on the second key points of the first to-be-recognized image, image special effects to the first to-be-recognized image, and acquiring a second special-effect image by adding, based on the second key points of the second to-be-recognized image, image special effects to the second to-be-recognized image; and

playing a special-effect live-streaming video of the first account and a special-effect live-streaming video of the second account, wherein the special-effect live-streaming video of the first account includes the first special-effect image, and the special-effect live-streaming video of the second account includes the second special-effect image.

According to some embodiments of the present disclosure, a computer device is provided. The computer device includes: a processor, and a memory for storing one or more instructions executable by the processor, wherein the processor, when loading and executing the one or more instructions, is caused to perform:

acquiring a plurality of images;

acquiring a target image by stitching the plurality of images;

acquiring a plurality of first key points of the target image by inputting the target image into an image recognition model; and

determining, based on the plurality of first key points, second key points of each of the to-be-recognized images.

According to some embodiments of the present disclosure, a computer device is provided. The computer device includes: a processor, and a memory for storing one or more instructions executable by the processor, wherein the processor, when loading and executing the one or more instructions, is caused to perform:

acquiring a live video stream of a first account and a live video stream of a second account;

extracting a first to-be-recognized image from the live video stream of the first account and a second to-be-recognized image from the live video stream of the second account;

acquiring a target image by stitching the first to-be-recognized image and the second to-be-recognized image;

acquiring a plurality of first key points of the target image by inputting the target image into an image recognition model;

determining, based on the plurality of first key points, second key points of the first to-be-recognized image and the second to-be-recognized image;

acquiring a first special-effect image by adding, based on the second key points of the first to-be-recognized image, image special effects to the first to-be-recognized image, and acquiring a second special-effect image by adding, based on the second key points of the second to-be-recognized image, image special effects to the second to-be-recognized image; and

playing a special-effect live-streaming video of the first account and a special-effect live-streaming video of the second account, wherein the special-effect live-streaming video of the first account includes the first special-effect image; the special-effect live-streaming video of the second account includes the second special-effect image.

According to some embodiments of the present disclosure, a non-transitory computer-readable storage medium is provided. A processor of a computer device, when executing instructions in the storage medium, causes the computer device to perform:

acquiring a plurality of to-be-recognized images;

acquiring a target image by stitching the plurality of to-be-recognized images;

acquiring a plurality of first key points of the target image by inputting the target image into an image recognition model; and

determining, based on the plurality of first key points, second key points of each of the to-be-recognized images.

According to some embodiments of the present disclosure, a non-transitory computer-readable storage medium is provided. A processor of a computer device, when executing instructions in the storage medium, causes the computer device to perform:

acquiring a live video stream of a first account and a live video stream of a second account;

extracting a first to-be-recognized image from the live video stream of the first account and a second to-be-recognized image from the live video stream of the second account;

acquiring a target image by stitching the first to-be-recognized image and the second to-be-recognized image;

acquiring a plurality of first key points of the target image by inputting the target image into an image recognition model;

determining, based on the plurality of first key points, second key points of the first to-be-recognized image and the second to-be-recognized image;

acquiring a first special-effect image by adding, based on the second key points of the first to-be-recognized image; image special effects to the first to-be-recognized image, and acquiring a second special-effect image by adding, based on the second key points of the second to-be-recognized image, image special effects to the second to-be-recognized image; and

playing a special-effect live-streaming video of the first account and a special-effect live-streaming video of the second account, wherein the special-effect live-streaming video of the first account includes the first special-effect image; the special-effect live-streaming video of the second account includes the second special-effect image.

According to some embodiments of the present disclosure, a computer program product is provided. The computer program product includes computer program codes, and a computer, when running the computer program codes, is caused to perform:

acquiring a plurality of images;

acquiring a target image by stitching the plurality of to-be-recognized images;

acquiring a plurality of first key points of the target image by inputting the target image into an image recognition model; and

determining, based on the plurality of first key points, second key points of each of the to-be-recognized images.

According to some embodiments of the present disclosure, a computer program product is provided. The computer program product includes computer program codes, and a computer, when running the computer program codes, is caused to perform:

acquiring a live video stream of a first account and a live video stream of a second account;

extracting a first to-be-recognized image from the live video stream of the first account and a second to-be-recognized image from the live video stream of the second account;

acquiring a target image by stitching the first to-be-recognized image and the second to-be-recognized image;

acquiring a plurality of first key points of the target image by inputting the target image into an image recognition model;

determining, based on the plurality of first key points, second key points of the first to-be-recognized image and the second to-be-recognized image;

acquiring a first special-effect image by adding, based on the second key points of the first to-be-recognized image, image special effects to the first to-be-recognized image, and acquiring a second special-effect image by adding, based on the second key points of the second to-be-recognized image, image special effects to the second to-be-recognized image; and

playing a special-effect live-streaming video of the first account and a special-effect live-streaming video of the second account, wherein the special-effect live-streaming video of the first account includes the first special-effect image; the special-effect live-streaming video of the second account includes the second special-effect image.

### BRIEF DESCRIPTION OF THE DRAWINGS

FIG. 1 is a schematic flowchart of a method for recognizing images according to an embodiment of the present disclosure;

FIG. 2 is an application environment diagram of a method for recognizing images according to an embodiment of the present disclosure;

FIG. 3 is an application scenario of video live-streaming according to an embodiment of the present disclosure;

FIG. 4 is a schematic diagram of a video play interface according to an embodiment of the present disclosure;

FIG. 5 is a schematic diagram of adding image special effects during a video live-streaming process according to an embodiment of the present disclosure;

FIG. 6 is a schematic diagram of adding image special effects in a video play interface according to an embodiment of the present disclosure;

FIG. 7 is a schematic diagram of stitched edges of images according to an embodiment;

FIG. 8 is a schematic diagram of a stitched image according to an embodiment of the present disclosure;

FIG. 9 is a schematic diagram of key points of a stitched image according to an embodiment of the present disclosure;

FIG. 10 is a schematic diagram of key points of an image according to an embodiment of the present disclosure;

FIG. 11 is a schematic diagram of adding image special effects to images based on key points according to an embodiment of the present disclosure;

FIG. 12 is a flowchart of processes of determining key points of an image according to an embodiment of the present disclosure;

FIG. 13 is a schematic diagram of a two-dimensional coordinate system of a stitched image according to an embodiment of the present disclosure;

FIG. 14 is a schematic diagram of determining second key point coordinates according to an embodiment of the present disclosure;

FIG. 15 is a schematic flowchart of a method for video live-streaming according to an embodiment of the present disclosure;

FIG. 16 is a structural block diagram of a system for live-streaming according to an embodiment of the present disclosure;

FIG. 17 is a schematic flowchart of a method for video live-streaming according to an embodiment of the present disclosure;

FIG. 18 is a structural block diagram of an apparatus tier recognizing images according to an embodiment of the present disclosure;

FIG. 19 is a structural block diagram of an apparatus for video live-streaming according to an embodiment of the present disclosure; and

FIG. 20 is a structural block diagram of a computer device according to an embodiment of the present disclosure.

### DETAILED DESCRIPTION

In order to clarify the objects, technical solutions and advantages of the present disclosure, the present disclosure will be described in further detail below in combination with accompanying drawings and embodiments. It should be understood that the embodiments described herein are only configured to explain the present disclosure, but not to limit the present disclosure.

User information involved in the present disclosure is information authorized by users or fully authorized by all sides. For example, a to-be-recognized image, a live video stream of a first account, and a live video stream of a second account are all information authorized by the users or fully authorized by all sides.

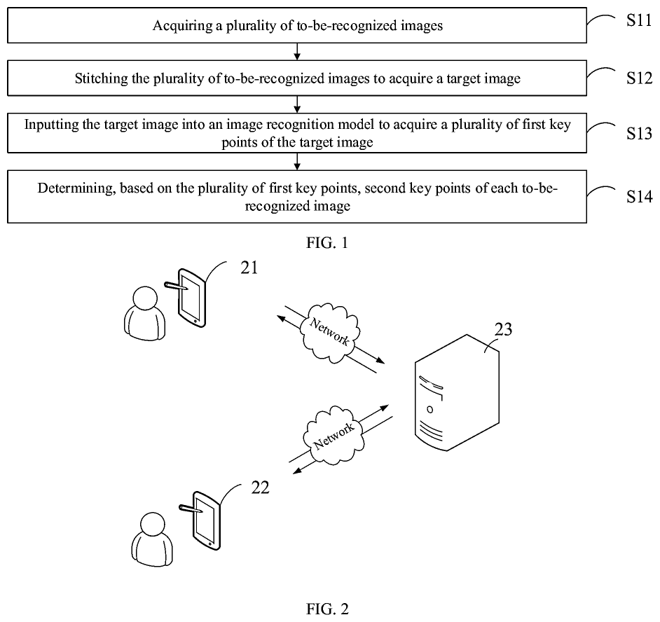

In some embodiments, as shown in FIG. 1, a method for recognizing images is provided. The method for recognizing images according to the present embodiment is applied to the application environment as shown in FIG. 2, The application environment includes a first terminal 21, a second terminal 22 and a server 23. The first terminal 21 and the second terminal 22 include, but are not limited to, personal computers, notebook computers, smart phones, tablet computers and portable wearable devices. The server 23 is implemented by an independent server or a server cluster composed of a plurality of servers.

In some embodiments, the above method for recognizing images is applied to the application scenarios of video communication, such as video calls, video conferences, video live-streaming, and co-hosting. For example, the above method for recognizing images is applied to the application scenario of adding image special effects to images in a video during a video communication process. In some embodiments, the above method for recognizing images is applied to the application scenario of recognizing a plurality of images.

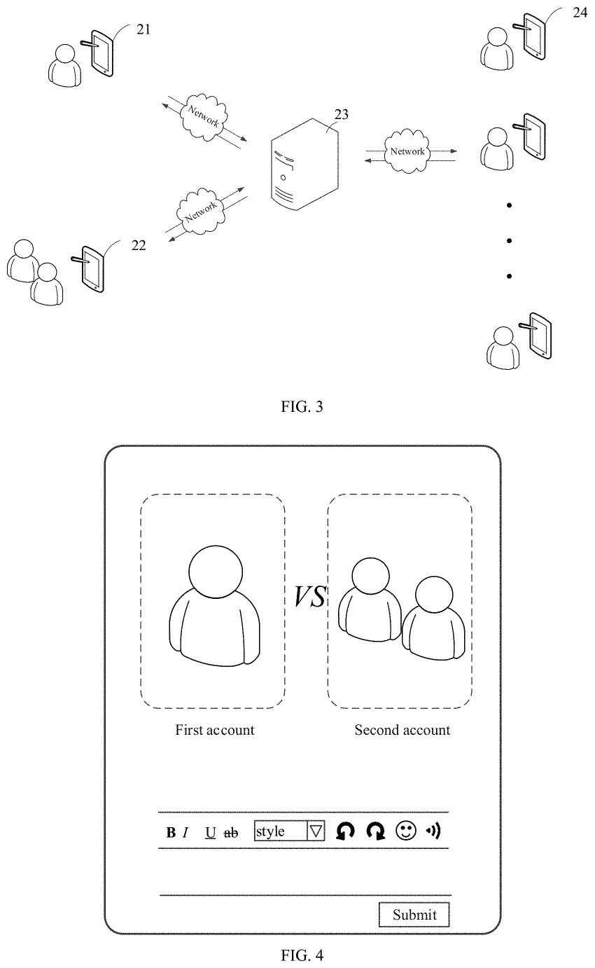

For example, referring to FIG. 3, the application scenario of video live-streaming according to an embodiment is provided. As shown in the FIG. 3, a first user logs in to a first account on a video live-streaming platform by the first terminal 21, and shoots 1w the first terminal 21. The first terminal 21 sends a shot video stream to the server 23, and the server 23 sends the video stream from the first account to the second terminal 22. A second user logs in to a second account on the video live-streaming platform by the second terminal 22 and shoots 1w the second terminal 22. The second terminal 22 sends the shot video stream to the server 23, and the server 23 sends the video stream form the second account to the first terminal 21. Thus, both the first terminal 21 and the second terminal 22 acquire video streams of the first account and the second account, that is, both the first terminal 21 and the second terminal 22 acquire two video streams. The first terminal 21 and the second terminal 22 perform video live-streaming based on the two video streams. Both the first user and the second user can view live-streaming pictures of themselves and the other side on the terminals. In addition, the server 23 may send the two video streams to third terminals 24 of other users, and other users view the live-streaming pictures of the first user and the second user by the third terminals 24.

Referring to FIG. 4, a schematic diagram of a video play interface according to an embodiment is provided. As shown in the FIG. 4, on the video play interface of the first terminal 21, the second terminal 22 and the third terminal 24, the video stream of the first account and the video stream of the second account are played simultaneously. In the above application scenario of video live-streaming, the first user and the second user performing the video live-streaming can view their own and the other's live-streaming pictures in real time, and communicate in at least one way, such as voice and text, and their own and the other's live-streaming pictures and content of their communication may also be viewed by other users in real time. Therefore, such an application scenario is also commonly referred to as “co-hosting”.

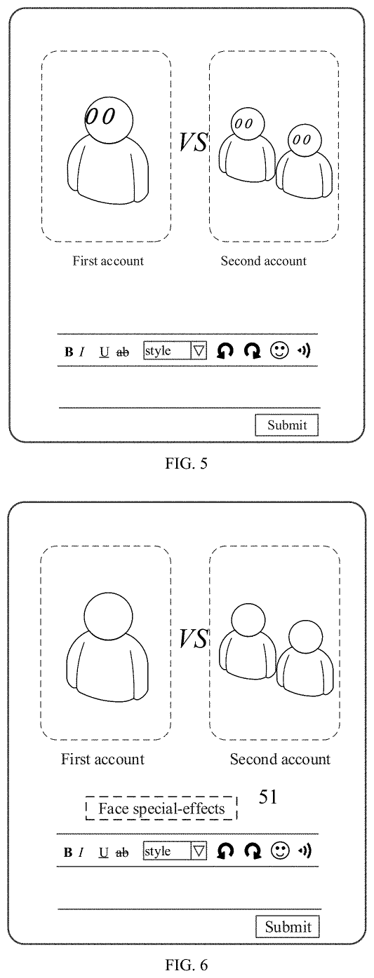

During the video live-streaming process, the users may add image special effects to people, backgrounds and other contents in video live-streaming. Referring to FIG. 5, a schematic diagram of adding image special effects during the video live-streaming process according to an embodiment is provided. As shown in FIG. 5, the second user submits a special-effect instruction by the second terminal 22, and expression special-effects are added to faces displayed in pictures of the first account and the second account on the video play interface.

In order to add the image special effects, the second terminal 22 needs to create an image recognition instance to perform image recognition on consecutive multi-frame images in the video stream. Key points in the images are recognized, the image special effects are added based on the key points in the images, and the images with the image special effects are acquired and displayed. In the above application scenario of video live-streaming, due to the two video streams, the second terminal 22 needs to create the image recognition instances for the images in the two video streams, so as to output the images to an image recognition model, and the key points of the images in the two video streams are output by the image recognition model.

However, executing the image recognition instances to perform image recognition by the image recognition model needs to consume processing resources of the second terminal 22. In order to ensure a real-time video live-streaming, multiple image recognition instances need to be executed simultaneously to perform image recognition. Therefore, the methods for recognizing images in the related art need to consume a lot of processing resources of the terminal. For terminals with poor performances, executing multiple image recognition instances to perform image recognition on multiple video streams simultaneously may cause the problems such as picture freeze and delay due to insufficient processing resources.

In the case that the second terminal 22 creates the image recognition instance, the second terminal 22 performs image recognition processing based on the image recognition instance, and inputs the image into the image recognition model. In the case that the image recognition processing is performed by the image recognition model, the second terminal 22 scans each pixel point in the entire image in a certain order, and each scanning processing consumes more processing resources of the terminal. Therefore, the applicant provides a new method for recognizing images. The method for recognizing images is applied to the above application scenarios, and can perform image recognition by a single image recognition instance, which reduces the consumption of processing resources of the terminal, and improves the efficiency of image recognition.

The method for recognizing images in the present embodiment shown in FIG. 1 is executed by the second terminal 22 and includes the following steps.

In S11, a plurality of to-be-recognized images are acquired.

In S12, the plurality of to-be-recognized images are stitched to acquire a target image.

In S13, the target image is input into an image recognition model to acquire a plurality of first key points of the target image.

In S14, based on the plurality of first key points, second key points of each to-be-recognized image are determined.

Regarding S11, the to-be-recognized images are images that are to be recognized currently to acquire the key points. In some embodiments, the method for processing images is applied in the application scenario of video communication, and the plurality of to-be-recognized images are images in two video streams acquired by the second terminal 22. Video applications are installed in the first terminal 21 and the second terminal 22. A first user logs in to a first account of a video application platform by the video application of the first terminal 21, and a second user logs in to a second account of the video application platform by the video application of the second terminal 22. The first terminal 21 and the second terminal 22 are connected through the server 23 for video communication. The first user shoots by the first terminal 21 to acquire a video stream of the first account, and forwards the video stream of the first account to the second terminal 22 through the server 23. The second user shoots by the second terminal 22 to acquire a video stream of the second account. Thus, the second terminal 22 acquires two video streams.

The video application of the second terminal 22 provides a video play interface, in which video play is performed based on the images in video streams of the first account and the second account. For example, referring to FIG. 4, the video play interface of the second terminal 22 is divided into left and right interfaces, the left interface displays consecutive multi-frame images in the video stream of the first account, and the right interface displays consecutive multi-frame images in the video stream of the second account.

The video application of the second terminal 22 provides a portal for adding special-effects for the user to request to add the image special effects. For example, referring to FIG. 6, a virtual button 51 of “facial expression special-effects” is arranged on the video play interface, and the user may click on the virtual button 51 to add the image special effects of expression effects to faces in the images. In response to the request of adding the image special effects of the user, the second terminal 22 extracts the images from two video streams, Because each video stream contains a plurality of images, the second terminal 22 extracts one frame or consecutive multi-frame images from the two video streams, thereby acquiring the images of the first account and the images of the second account. In the embodiment of the present disclosure, the images of the first account and the images of the second account are taken as the above plurality of to-be-recognized images.

Regarding S12, the target image is an image acquired by stitching the plurality of to-be-recognized images. In some embodiments, the second terminal 22 stitches the to-be-recognized images extracted from the two video streams, and determines the stitched image as the above target image.

There are multiple implementations of stitching image. In some embodiments, for each to-be-recognized image, the second terminal 22 selects one of a plurality of image edges of the to-be-recognized image as a stitched edge, and stitches the plurality of to-be-recognized images based on the stitched edge, such that the stitched edges of all images are overlapped, thereby completing the stitching of the plurality of to-be-recognized images.

In some embodiments, the second terminal 22 performs left-right stitching on the plurality of to-be-recognized images. For example, for two to-be-recognized images, the image edge on the right side of one image is selected as the stitched edge, and the image edge on the left side of the other image is selected as the stitched edge, and stitching is performed based on the stitched edges of the two images.

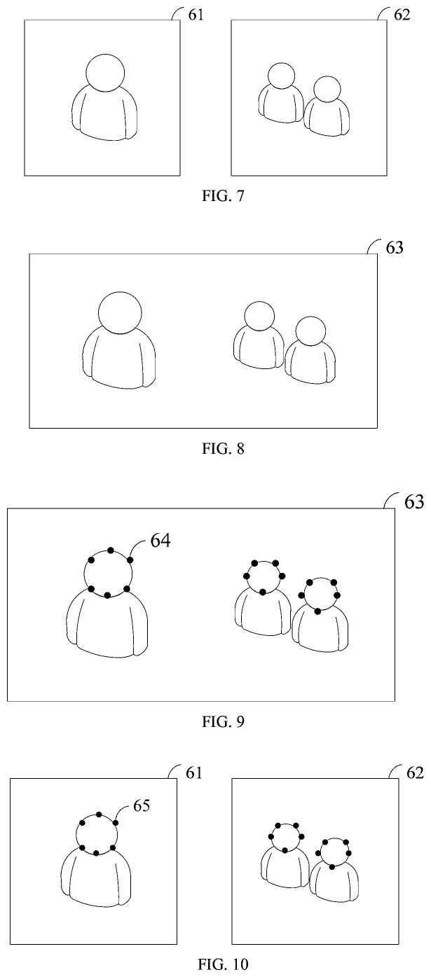

Referring to FIG. 7, a schematic diagram of the stitched edges of the to-be-recognized images according to an embodiment is provided. As shown in FIG. 7, there are two to-be-recognized images currently, which are respectively an image 61 extracted from the video stream of the first account and an image 62 extracted from the video stream of the second account. The image edge on the right side of the image 61 is selected as the stitched edge, the image edge on the left side of the image 62 is selected as the stitched edge, and the stitching is performed based on the stitched edges of the image 61 and the image 62.

Referring to FIG. 8, a schematic diagram of a stitched image according to one embodiment is provided. As shown in FIG. 8, in the case that stitching is performed based on the stitched edges of the image 61 and the image 62, a target image 63 formed by the image 61 and the image 62 is acquired.

In some embodiments, the second terminal 22 performs upper-lower stitching on the plurality of to-be-recognized images. For example, the second terminal 22 selects the image edge at the upper side of one to-be-recognized image as the stitched edge, and selects the image edge at the lower side of the other to-be-recognized image as the stitched edge, and stitching is performed based on the stitched edges at the upper and lower sides of the to-be-recognized images.

In some embodiments, the second terminal 22 firstly generates a blank image, adds the plurality of to-be-recognized images to the blank image, and determines the image to which the plurality of to-be-recognized images are added as the above target image.

In some embodiments, the second terminal 22 uses multiple stitching manners to stitch the plurality of to-be-recognized images into the above target image, and the present disclosure does not limit the stitching manners.

In some embodiments, each to-be-recognized image is substantially formed by a pixel array, and each pixel point of the to-be-recognized image has a corresponding pixel value and pixel coordinates. Stitching the plurality of to-be-recognized images into the target image is substantially to generate a new pixel array representing the target image based on the pixel arrays in the to-be-recognized images. Stitching the plurality of to-be-recognized images into the stitched image is to change the pixel values and pixel coordinates in the pixel array.

Regarding S13, the first key point is a pixel point with a specific feature in the target image. The first key point is a key point of any part of a target object in the target image. For example, the first key point is a face key point or a key point of five senses.

In some embodiments, the second terminal 22 creates an image recognition instance for image recognition of the target image, the second terminal 22 executes the image recognition instance to input the target image into the image recognition model, and the second terminal 22 scans each pixel point in the target image to determine whether a certain pixel point is the key point. The second terminal 22 recognizes and acquires the key points in the target image by the image recognition model, as the above first key points. The second terminal 22 determines, based on the first key points in the target image, the pixel coordinates of the first key points in a two-dimensional coordinate system established with the target image.

Referring to FIG. 9, a schematic diagram of key points of a first target image is provided according to one embodiment. As shown in FIG. 9, upon image recognition, first key points 64 having face contour features in the first image 63 are acquired.

Regarding S14, in some embodiments, the second terminal 22 uses the first key points of the target image to determine one or more pixel points of each to-be-recognized image as the key points, to acquire the above second key points. For example, in response to acquiring the first key points of the target image, the second terminal 22 determines the pixel points corresponding to the first key points in the to-be-recognized image, and takes the pixel points corresponding to the first key points in the to-be-recognized image as the second key points in the to-be-recognized image.

Referring to FIG. 10, a schematic diagram of second key points of the to-be-recognized image according to one embodiment is provided. As shown in FIG. 10, in response to determining the first key points 64 of the target image 63, the second terminal 22 determines second key points 65 of the image 61 and the image 62.

In some embodiments, in response to the second terminal 22 acquiring the second key points of each image, the second terminal 22 adds, based on the second key points of each to-be-recognized image, the image special effects to each to-be-recognized image and displays the image added with the image special effects.

Referring to FIG. 11, a schematic diagram of adding the image special effects to the to-be-recognized images based on the second key points according to an embodiment is provided. As shown in FIG. 11, in response to acquiring the second key points 65 having the face contour features in the image 61 and the image 62, the second terminal 22 adds expression special-effects to the faces.

There are various implementations for the second terminal 22 to determine the second key points of each to-be-recognized image based on the first key points of the target image.

In some embodiments, in response to acquiring the target image, the second terminal 22 records pixel points corresponding to each pixel point in the to-be-recognized image in the target image. In the case that the first key points of the target image are acquired, the pixel points corresponding to the first key points of the target image in each to-be-recognized image are determined, thereby acquiring the second key points of the to-be-recognized image.

In some embodiments, the second terminal 22 firstly determines at least one pixel point in the to-be-recognized image as a reference pixel point, for example, determines the pixel point at the end point of the image in the to-be-recognized image as the reference pixel point, and records the pixel coordinates of the reference pixel point in the two-dimensional coordinate system established with the to-be-recognized image, as pre-stitching reference pixel coordinates. In response to acquiring the target image, the second terminal 22 determines the pixel coordinates of the reference pixel point in the two-dimensional coordinate system established with the target image, as post-stitching reference pixel coordinates. The second terminal 22 determines coordinate conversion parameters based on difference values between the pre-stitching reference pixel coordinates and the post-stitching reference pixel coordinates. In response to acquiring the first key point of the target image, the second terminal 22 converts, based on the pixel coordinates of the first key point in the target image and the above coordinate conversion parameters, the pixel coordinates of the first key point in the target image into the pixel coordinates of the corresponding pixel point in the to-be-recognized image, and the pixel point corresponding to the converted pixel coordinates is the second key point on the to-be-recognized image, thereby acquiring the second key point of the to-be-recognized image.

The second terminal 22 may also determine the second key points of each to-be-recognized image based on the first key points of the target image in other ways.

In some embodiments, the second terminal 22 executes the image recognition instance, the target image is input into the image recognition model, and the process of recognizing the target image by the image recognition model is substantially the process of scanning each pixel point in the whole image by the second terminal 22. The scanning processing for each image consumes more processing resources of the terminal. In the above method for recognizing images, the plurality of images are stitched into the target image, and the target image is input into the image recognition model. Substantially, the second terminal only needs to perform single scanning processing on the target image, and does not need to perform scanning processing of multiple times on the plurality of to-be-recognized images, thereby saying the processing resources required for scanning processing.

In the above method for recognizing images, the plurality of to-be-recognized images are acquired, the plurality of to-be-recognized images are stitched into the target image, and the target image is input to the image recognition model to acquire the first key points of the target image. Based on the first key points, the second key points of the plurality of to-be-recognized images are determined, such that the image recognition of the plurality of to-be-recognized images can be realized only by inputting the target image into the image recognition model, and the key points of the plurality of to-be-recognized images are acquired, without a need to execute multiple image recognition instances for the plurality of to-be-recognized images. The plurality of to-be-recognized images are input into the image recognition model, so as to recognize the key points of the plurality of to-be-recognized images, thereby saving the processing resources required by the second terminal 22 for image recognition and solving the problem that the methods for recognizing images in the related art consume the processing resources of the terminal seriously.

Moreover, in the case that the above method fir recognizing images is applied to the application scenario of adding the image special effects during video communication, the second terminal 22 is enabled to reduce the consumption of the processing resources in response to recognizing the key points of the images to add the image special effects. Because the consumption of the processing resources is reduced, the problems such as picture freeze and delay of video communication caused by insufficient processing resources of the second terminal 22 are avoided.

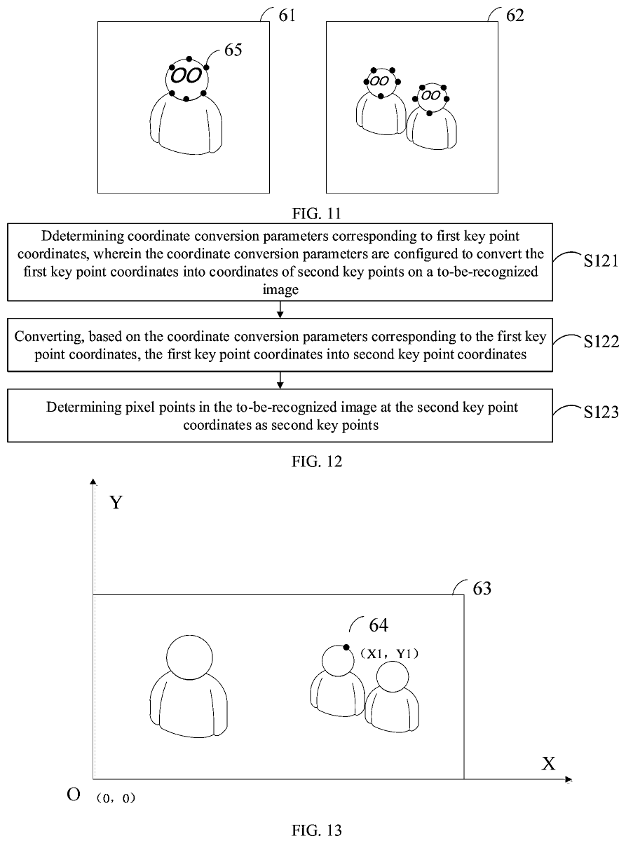

As shown in FIG. 12, in some embodiments, a flowchart of processes of determining the key points of the image is provided, the pixel coordinates of the first key points on the target image are first key point coordinates, and S14 includes the following steps.

In S121, coordinate conversion parameters corresponding to the first key point coordinates are determined, wherein the coordinate conversion parameters are configured to convert the first key point coordinates into coordinates of second key points on the to-be-recognized image.

In S122, based on the coordinate conversion parameters corresponding to the first key point coordinates, the first key point coordinates are converted into second key point coordinates.

In S123, pixel points at the second key point coordinates in the to-be-recognized image are determined as the second key points.

Regarding S121, the coordinate conversion parameters corresponding to the first key point coordinates may be coordinate conversion parameters of the to-be-recognized image corresponding to the first key points, and the coordinate conversion parameters are parameters of performing pixel point coordinate conversion between the to-be-recognized image and the target image. Correspondingly, the step includes: for each first key point, determining the to-be-recognized image corresponding to the first key point, and determining the coordinate conversion parameters of the to-be-recognized image.

In some embodiments, in response to acquiring the first key point, the second terminal 22 determines the pixel coordinates of the first key point on the target image, as the above first key point coordinates.

In some embodiments, in order to determine the pixel coordinates of the first key point on the target image, a two-dimensional coordinate system is firstly established based on the target image, and each pixel point on the target image has corresponding pixel coordinates in the two-dimensional coordinate system.

FIG. 13 provides a schematic diagram of the two-dimensional coordinate system of the target image according to one embodiment. As shown in FIG. 13, the end point at the lower left end of the target image is determined as an original point O of the two-dimensional coordinate system, the horizontal edge at the lower side of the target image is determined as an X axis, and the vertical edge at the left side of the target image is determined as a Y axis, thereby establishing the two-dimensional coordinate system of the target image. Each first key point 64 in the target image has corresponding first key point coordinates (X1, Y1) in the two-dimensional coordinate system.

In response to determining one or more first key point coordinates, the second terminal 22 determines the coordinate conversion parameters corresponding to the first key point coordinates.

In some embodiments, in response to the second terminal 22 stitching the plurality of to-be-recognized images into the target image, the pixel coordinates of the pixel points of the to-be-recognized images on the to-be-recognized images are to be changed to the pixel coordinates of the pixel points on the target image. In order to determine the pixel coordinates of one certain first key point on the to-be-recognized image based on the pixel coordinates of such first key point in the target image, the coordinate conversion parameters need to be configured to convert the pixel coordinates of the first key point in the target image into the pixel coordinates of the first key point on the to-be-recognized image.

The above coordinate conversion parameters are acquired based on differences between the pixel coordinates of the pixel point of the to-be-recognized image on the to-be-recognized image and the pixel coordinates of the pixel point on the target image in response to acquiring the target image.

For example, the pixel coordinates of a certain pixel point on the to-be-recognized image are (5, 10), and the pixel coordinates of the pixel point on the target image are (15, 10), thereby acquiring coordinate difference values (10, 0) between the pixel coordinates of the pixel point of the to-be-recognized image on the to-be-recognized image and the pixel coordinates of the pixel point on the target image, and determining the coordinate difference values as the above coordinate conversion parameters.

In response to performing image stitching, the differences between the pixel coordinates of different pixel points on the to-be-recognized image and the pixel coordinates of the pixel points on the target image are also different, Therefore, based on the first key point coordinates, the coordinate conversion parameters corresponding to the first key point coordinates are determined, so as to perform coordinate conversion based on the corresponding coordinate conversion parameters.

Regarding S122, in some embodiments, the coordinate conversion parameters corresponding to the first key point coordinates are the coordinate conversion parameters of the to-be-recognized image, then the step includes: converting, based on the coordinate conversion parameters of the to-be-recognized image, the first key point coordinates to the second key point coordinates.

In some embodiments, the second terminal 22 acquires the coordinate conversion parameters corresponding to the first key point coordinates, and converts the first key point coordinates into the second key point coordinates based on the coordinate conversion parameters. The pixel coordinates of the key point on the target image are restored to the pixel coordinates of the key point on the to-be-recognized image by the coordinate conversion parameters.

Regarding S123, in some embodiments, in response to determining the second key point coordinates, the second terminal 22 searches the to-be-recognized image for the pixel point at the second key point coordinates as the second key point of the to-be-recognized image, and then marks the second key point.

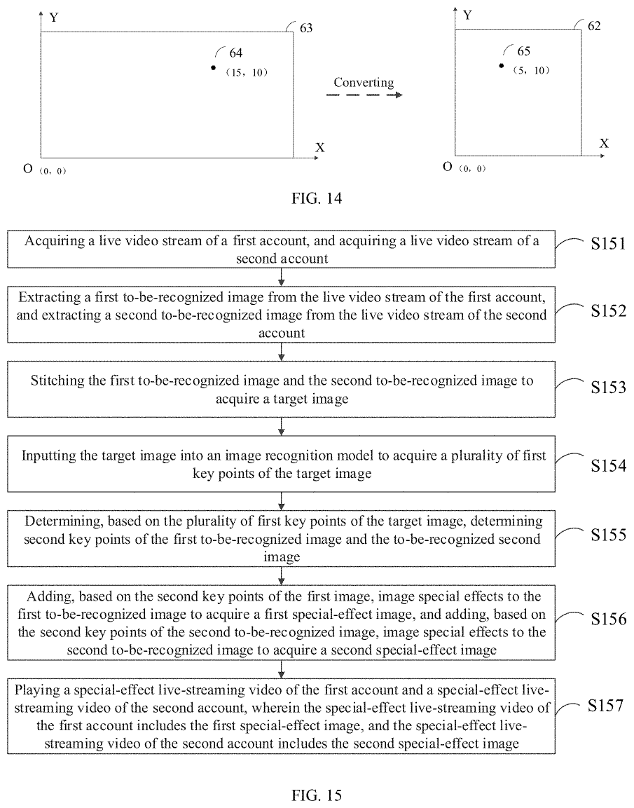

FIG. 14 provides a schematic diagram of determining the second key point coordinates according to one embodiment. Assuming that the first key point coordinate of the first key point 64 of the target image 63 is (15, 10), the coordinate conversion parameters is coordinate difference value (10, 0), the coordinate difference value (10, 0) is subtracted from the first key point coordinate (15, 10) to acquire the second key point coordinate (5, 10), and the image 62 is searched for the pixel point at the second key point coordinate (5, 10) to acquire the second key point 65.

In the above method for recognizing images, the coordinate conversion parameters corresponding to the first key point coordinates are firstly determined, the first key point coordinates are converted into the second key point coordinates based on the coordinate conversion parameters, and finally the pixel point in the to-be-recognized image at the second key point coordinates is determined as the second key point of the to-be-recognized image. Therefore, the second key points of each to-be-recognized image can be determined based on the plurality of first key points of the target image by a small number of coordinate conversion parameters. There is no need to establish corresponding relationships between the pixel points of the to-be-recognized image and the pixel points of the target image one by one, which further saves the processing resources of the second terminal 22.

In some embodiments, the target image includes a plurality of image regions, the plurality of image regions contain corresponding to-be-recognized images, and S121 includes:

determining, in the plurality of image regions, a target image region corresponding to the first key point coordinates in the target image, and determining, based on the to-be-recognized image corresponding to the target image region, the coordinate conversion parameters corresponding to the first key point coordinates.

In some embodiments, in the case that the plurality of to-be-recognized images are stitched into the target image, the second terminal 22 determines an image boundary of the to-be-recognized image based on the pixel coordinates of the pixel points in each to-be-recognized image, and based on the image boundary of the to-be-recognized image, the target image is divided to acquire the multiple image regions. In response to acquiring the first key points of the target image, the second terminal 22 firstly determines the image region corresponding to the first key point coordinates in the target image, as the above target image region. Then, the second terminal 22 determines the to-be-recognized image corresponding to the target image region, and determines the coordinate conversion parameters corresponding to the first key point coordinates based on the to-be-recognized image corresponding to the target image region.

In the above method for recognizing images, based on the image region corresponding to the first key points on the target image, the coordinate conversion parameters corresponding to the first key points are determined, without a need to record the corresponding coordinate conversion parameters for each pixel point on the target image, which saves the processing resources required for image recognition, reduces consumption of the terminal, and improves the efficiency of image recognition.

In some embodiments, after SI 2, the method also includes:

determining the image boundary of the to-be-recognized image based on the pixel coordinates of the pixel points in to-be-recognized the image;

determining the pixel coordinates of the image boundary of the to-be-recognized image on the target image, and acquiring image region division coordinates; and

dividing, based on the image region division coordinates, the target image into a plurality of image regions.

In some embodiments, the second terminal 22 determines whether the pixel point is at the image boundary of the to-be-recognized image based on the pixel coordinates of the pixel point in the to-be-recognized image, so as to determine the image boundary of the to-be-recognized image. Then, the second terminal 22 searches the pixel coordinates of the image boundary of the to-be-recognized image on the target image, thereby acquiring the image region division coordinates. Based on the image region division coordinates, the target image is divided into several image regions, and each image region has the corresponding to-be-recognized image.

In the above method for recognizing images, the image boundary of the to-be-recognized image is determined by the pixel coordinates of the pixel points of the to-be-recognized image, the image boundary is configured to determine the image region division coordinates on the target image, and based on the image region division coordinates, the target image is divided into the image regions corresponding to the plurality of to-be-recognized images, such that the image regions corresponding to the to-be-recognized images in the target image are acquired conveniently, which improves the efficiency of image recognition.

In some embodiments, upon S12, the method also includes:

determining at least one pixel point in the to-be-recognized image as a reference pixel point, determining pixel coordinates of the reference pixel point on the to-be-recognized image, to acquire the pre-stitching reference pixel coordinates, and determining the pixel coordinates of the reference pixel point on the target image to acquire the post-stitching reference pixel coordinates, and based on the post-stitching reference pixel coordinates and the pre-stitching reference pixel coordinates, determining the coordinate conversion parameters.

In some embodiments, the coordinate conversion parameters corresponding to the first key point in each to-be-recognized image are identical. Therefore, in response to determining the coordinate conversion parameters, the second terminal 22 records a corresponding relationship between the to-be-recognized image and the coordinate conversion parameters, such that the coordinate conversion parameters corresponding to the first key point can be determined from the corresponding relationship between the to-be-recognized image and the coordinate conversion parameters directly based on the to-be-recognized image corresponding to the first key point.

In some embodiments, the second terminal 22 determines any one or more pixel points in the to-be-recognized image as the above reference pixel points. For example, the second terminal 22 determines the pixel point at the end point in the to-be-recognized image as the above reference pixel point.

In some embodiments, the second terminal 22 determines difference values between the post-stitching reference pixel coordinates and the pre-stitching reference pixel coordinates as the coordinate conversion parameters, or determines difference values between the pre-stitching reference pixel coordinates and the post-stitching reference pixel coordinates as the coordinate conversion parameters.

In some embodiments, S122 includes:

In the case that the coordinate conversion parameters are the difference values between the post-stitching reference pixel coordinates and the pre-stitching reference pixel coordinates, difference values between the first key point coordinates and the coordinate conversion parameters are determined as the second key point coordinates. In the case that the coordinate conversion parameters are the difference values between the pre-stitching reference pixel coordinates and the post-stitching reference pixel coordinates, sums of the first key point coordinates and the coordinate conversion parameters are determined as the second key point coordinates.

For example, the first key point coordinate of a certain first key point on the target image is (20, 20), and the coordinate conversion parameter corresponding to the first key point is the coordinate difference value (10, 0). Therefore, the coordinate difference value (10, 0) is subtracted from the first key point coordinate (20, 20) to acquire the second key point coordinate (10, 20), and the pixel point at the second key point coordinate (10, 20) on the to-be-processed image is determined as the second key point. Thus, by using the coordinate conversion parameter, the second key point of the image is acquired based on the first key point of the target image.

In some embodiments, S12 includes:

scaling at least one of the plurality of to-be-recognized images to acquire a plurality of images of an equal size, and stitching the plurality of images of the equal size to acquire the target image.

In some embodiments, the second terminal 22 scales all the images in the plurality of to-be-recognized images, or performs scaling processing on part of the images in the plurality of to-be-recognized images. For example, the image size of one image A is 720 pixels*1280 pixels, the image size of the other image B is 540 pixels*960 pixels, the other image B is scaled to acquire a scaled image B′ of 720 pixels*1280 pixels, and the image A and the scaled image B′ are stitched to acquire the target image with an image size of 1440 pixels*1280 pixels.

In the above method for recognizing images, the to-be-recognized image is scaled into the images of the same size, such that the terminal stitches the images of the equal size into the target image, which reduces the resources consumed by image stitching processing.

In some embodiments, S11 includes:

receiving multiple video streams, the multiple video streams being from the first account and the second account: and

extracting a first to-be-recognized image from the video stream of the first account, and extracting a second to-be-recognized image from the video stream of the second account.

In response to determining the second key points of each of the to-be-recognized images based on the first key points of the target image, the method also includes:

adding, based on the second key points of the first to-be-recognized image, image special effects to the first to-be-recognized image to acquire a first special-effect image, and adding, based on the second key points of the second to-be-recognized image, image special effects to the second to-be-recognized image to acquire a second special-effect image; and

playing a special-effect live-streaming video of the first account and a special-effect live-streaming video of the second account, wherein the special-effect live-streaming video of the first account includes the first special-effect image, and the special-effect live-streaming video of the second account includes the second special-effect image.

In some embodiments, the second terminal 22 receives the video streams of the first account and the second account, extracts the images from the video streams of the first account and the second account, and acquires the first to-be-recognized image and the second to-be-recognized image.

The target image is acquired by stitching the first to-be-recognized image and the second to-be-recognized image. The image recognition instance is created and executed, thereby inputting the target image into the image recognition model. The image recognition model outputs the first key points of the target image, and the second terminal 22 acquires the second key points of the first to-be-recognized image and the second to-be-recognized image based on the first key points.

The second terminal 22 adds the image special effects to the first to-be-recognized image based on the second key points of the first to-be-recognized image to acquire the above first special-effect image. Similarly, the second terminal 22 adds the image special effects to the second to-be-recognized image based on the second key points of the second to-be-recognized image to acquire the above second special-effect image.

Referring to FIG. 11, based on second key points 65 having face contour features of the first to-be-recognized image 61 and the second to-be-recognized image 62, expression special-effects are added to the faces in the to-be-recognized images.

For the consecutive multi-frame to-be-recognized images in the video stream, the above multiple steps are repeatedly executed. The second terminal 22 may acquire the consecutive multi-frame special-effect images, and the consecutive multi-frame special-effect images are displayed in sequence, i.e., the special-effect live-streaming videos including the special-effect images are played.

In some embodiments, as shown in FIG. 15, a method for video live-streaming is also provided, and the method should be executed by the second terminal 22 in FIG. 2 and includes the following steps.

In S151, a live video stream of a first account is acquired, and a live video stream of a second account is acquired.

In S152, a first to-be-recognized image is extracted from the live video stream of the first account, and a second to-be-recognized image is extracted from the live video stream of the second account.

In S153, the first to-be-recognized image and the second to-be-recognized image are stitched to acquire a target image.

In S154, the target image is input into an image recognition model to acquire a plurality of first key points of the target image.

In S155, based on the plurality of first key points, second key points of the first to-be-recognized image and the second to-be-recognized image are determined.

In S156, based on the second key points of the first to-be-recognized image, image special effects are added to the first to-be-recognized image to acquire a first special-effect image, and based on the second key points of the second to-be-recognized image, image special effects are added to the second to-be-recognized image to acquire a second special-effect image.

In S157, a special-effect live-streaming video of the first account and a special-effect live-streaming video of the second account are played, wherein the special-effect live-streaming video of the first account includes the first special-effect image, and the special-effect live-streaming video of the second account includes the second special-effect image.

The implementation of each of the above steps has been described in detail in the above embodiments, and thus will not be repeated here.

In the above method for video live-streaming, the live video streams of the first account and the second account are acquired, the first to-be-recognized image and the second to-be-recognized image are extracted, the first to-be-recognized image and the second to-be-recognized image are stitched into the target image, the target image is input into the image recognition model, to acquire the first key points of the stitched target image, and second key points of the to-be-recognized images are determined based on the first key points. Therefore, the image recognition of the plurality of to-be-recognized images can be realized by only inputting the target image into the image recognition model, and the key points of the plurality of to-be-recognized images are acquired, without a need to execute multiple image recognition instances for the plurality of to-be-recognized images. The plurality of to-be-recognized images are input into the image recognition model, so as to recognize the key points of the plurality of to-be-recognized images, thereby saving the processing resources required by the terminal for image recognition, and solving the problem that the methods for recognizing images in the related art consume the processing resources of the terminal seriously.

Moreover, in the case that the above method for recognizing images is applied to the application scenario of adding the image special effects during video communication, the terminal is enabled to reduce the consumption of the processing resources in response to recognizing the key points of the images to add the image special effects. Because the consumption of the processing resources is reduced, the problems such as picture freeze and delay of video communication caused by insufficient processing resources of the terminal are avoided.

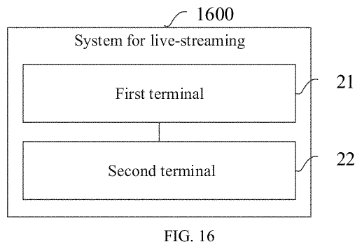

In some embodiments, as shown in FIG. 16, a system for live-streaming 1600 is also provided, and the system includes a first terminal 21 and a second terminal 22.

The first terminal 21 is configured to generate a live video stream of a first account, and send the live video stream of the first account to the second terminal 22.

In some embodiments, the first terminal 21 sends the live video stream of the first account to the second terminal 22 by a server 23.

The second terminal 22 is configured to generate a live video stream of a second account.

The second terminal 22 is further configured to extract a first to-be-recognized image from the live video stream of the first account, and extract a second to-be-recognized image from the live video stream of the second account.

The second terminal 22 is further configured to input a stitched image into an image recognition model to acquire a plurality of first key points of a target image.

The second terminal 22 is further configured to determine second key points of the first to-be-recognized image and the second to-be-recognized image based on the plurality of first key points.

The second terminal 22 is further configured to add image special effects to the first to-be-recognized image based on the second key points of the first to-be-recognized image to acquire a first special-effect image, and add image special effects to the second to-be-recognized image based on the second key points of the second to-be-recognized image to acquire a second special-effect image.

The second terminal 22 is further configured to play a special-effect live-streaming video of the first account and a special-effect live-streaming video of the second account, wherein the special-effect live-streaming video of the first account includes the first special-effect image, and the special-effect live-streaming video of the second account includes the second special-effected image.

The implementations of the steps executed by the first terminal 21 and the second terminal 22 have been described in detail in the above embodiments, and thus will not be repeated here.

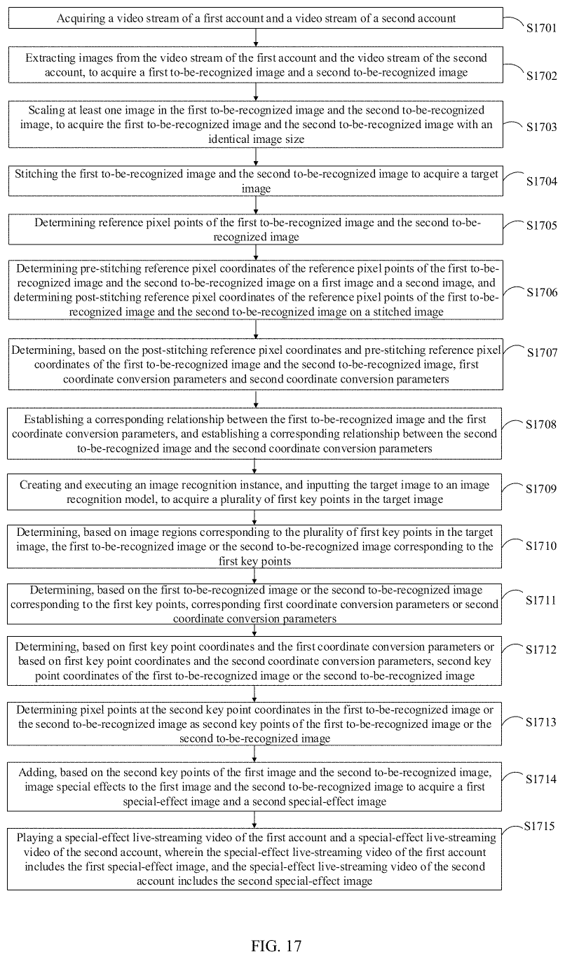

In order to facilitate those skilled in the art to deeply understand the embodiments of the present disclosure, as shown in FIG. 17, the image processing performed in a video live-streaming process is taken as an example for description, and the method is executed by the second terminal 22 and includes the following steps.

In S1701, a video stream of a first account and a video stream of a second account are acquired.

In S1702, images are extracted from the video stream of the first account and the video stream of the second account, to acquire a first to-be-recognized image and a second to-be-recognized image.

In S1703, at least one image in the first to-be-recognized image and the second to-be-recognized image is scaled, to acquire the first to-be-recognized image and the second to-be-recognized image with an identical image size.

In S1704, the first to-be-recognized image and the second to-be-recognized image are stitched to acquire a target image.

In S1705, reference pixel points of the first to-be-recognized image and the second to-be-recognized image are determined.

In S1706, pre-stitching reference pixel coordinates of the reference pixel points of the first to-be-recognized image and the second to-be-recognized image on a first image and a second image are determined, and post-stitching reference pixel coordinates of the reference pixel points of the first to-be-recognized image and the second to-be-recognized image on a stitched image are determined.

In S1707, based on the post-stitching reference pixel coordinates and pre-stitching reference pixel coordinates of the first to-be-recognized image and the second to-be-recognized image, first coordinate conversion parameters and second coordinate conversion parameters are determined.

In S1708, a corresponding relationship between the first to-be-recognized image and the first coordinate conversion parameters is established, and a corresponding relationship between the second to-be-recognized image and the second coordinate conversion parameters is established.

In S1709, an image recognition instance is created and executed, and the target image is input to an image recognition model to acquire a plurality of first key points in the target image.

In S1710, based on image regions corresponding to the plurality of first key points in the target image, the first to-be-recognized image or the second to-be-recognized image corresponding to the first key points is determined.

In S1711, based on the first to-be-recognized image or the second to-be-recognized image corresponding to the first key points, corresponding first coordinate conversion parameters or second coordinate conversion parameters are determined.

In S1712, based on first key point coordinates and the first coordinate conversion parameters or based on first key point coordinates and the second coordinate conversion parameters, second key point coordinates of the first to-be-recognized image or the second to-be-recognized image are determined.

In S1713, pixel points at the second key point coordinates in the first to-be-recognized image or the second to-be-recognized image are determined as second key points of the first to-be-recognized image or the second to-be-recognized image.

In S1714, based on the second key points of the first to-be-recognized image and the second to-be-recognized image, image special effects are added to the first to-be-recognized image and the second to-be-recognized image to acquire a first special-effect image and a second special-effect image.

In S1715, a special-effect live-streaming video of the first account and a special-effect live-streaming video of the second account are played, wherein the special-effect live-streaming video of the first account includes the first special-effect image, and the special-effect live-streaming video of the second account includes the second special-effect image.

In some embodiments, although various steps in the flowcharts of the present disclosure are displayed in sequence according to arrows, these steps are not necessarily executed sequentially in the order indicated by the arrows. Unless explicitly stated herein, these steps are not performed in strict order, and these steps are performed in other orders. Moreover, at least part of the steps in the flowcharts of the present disclosure include multiple sub-steps or multiple stages. These sub-steps or stages are not necessarily performed and completed at the same moment, but are performed at different moments. The order of performing these sub-steps or stages is also not necessarily in sequence, but is in turns or alternately with other steps or at least part of the sub-steps or stages of other steps.

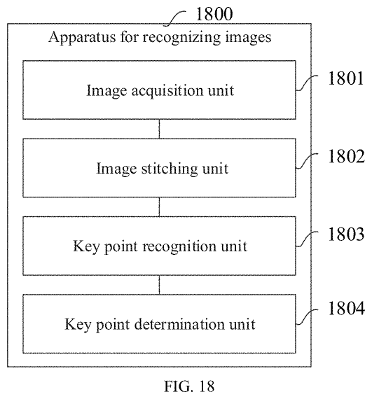

In some embodiments, as shown in FIG. 18, an apparatus for recognizing images 1800 is provided, and the apparatus includes:

an image acquisition unit 1801, configured to acquire a plurality of to-be-recognized images;

an image stitching unit 1802, configured to stitch e plurality of to-be-recognized images to acquire a target image;

a key point recognition unit 1803, configured to input the target image into an image recognition model to acquire a plurality of first key points of the target image; and

a key point determination unit 1804, configured to determine, based on the p of first key points, second key points of each of the to-be-recognized images.

In some embodiments, pixel coordinates of the first key point on the target image are first key point coordinates, and the key point determination unit 1804 is configured to:

determine coordinate conversion parameters corresponding to the first key point coordinates, wherein the coordinate conversion parameters are configured to convert the first key point coordinates into coordinates of the second key point on the to-be-recognized image;

convert, based on the coordinate conversion parameters corresponding to the first key point coordinates, the first key point coordinates into second key point coordinates; and

determine a pixel point in the to-be-recognized image at the second key point coordinates as the second key point.

In some embodiments, the target image includes a plurality of image regions, the plurality of image regions contain corresponding to-be-recognized images, and the key point determination unit 1804 is configured to:

determine, in the plurality of image regions, a target image region corresponding to the first key point coordinates; and

determine, based on the to-be-recognized image corresponding to the target image region, the coordinate conversion parameters corresponding to the first key point coordinates.

In some embodiments, the apparatus further includes:

a division unit, configured to: determine, based on pixel coordinates of pixel points in the to-be-recognized image, an image boundary of the to-be-recognized image, determine the pixel coordinates of the image boundary of the to-be-recognized image on the target image to acquire image region division coordinates, and divide, based on the image region division coordinates, the target image into the plurality of image regions.

In some embodiments, the key point determination unit 1804 is configured to:

determine at least one pixel point in the to-be-recognized image as a reference pixel point;

determine pixel coordinates of the reference pixel point on the to-be-recognized image to acquire pre-stitching reference pixel coordinates, and determine pixel coordinates of the reference pixel point on the target image to acquire post-stitching reference pixel coordinates; and

determine, based on the post-stitching reference pixel coordinates and the pre-stitching reference pixel coordinates, the coordinate conversion parameters.

In some embodiments, the key point determination unit 1804 is configured to:

determine difference values between the post-stitching reference pixel coordinates and the pre-stitching reference pixel coordinates as the coordinate conversion parameters; or,

determine difference values between the pre-stitching reference pixel coordinates and the post-stitching reference pixel coordinates as the coordinate conversion parameters.

In some embodiments, the key point determination unit 1804 is configured to:

determine, in response to the coordinate conversion parameters being the difference values between the post-stitching reference pixel coordinates and the pre-stitching reference pixel coordinates, difference values between the first key point coordinates and the coordinate conversion parameters as the second key point coordinates; and

determine, in response to the coordinate conversion parameters are the difference values between the pre-stitching reference pixel coordinates and the post-stitching reference pixel coordinates, sums of the first key point coordinates and the coordinate conversion parameters as the second key point coordinates.

In some embodiments, the image stitching unit 1802 is further configured to:

scale at least one of the plurality of to-be-recognized images to acquire a plurality of images of an equal size; and

stitch the plurality of images of the equal size to acquire the target image.

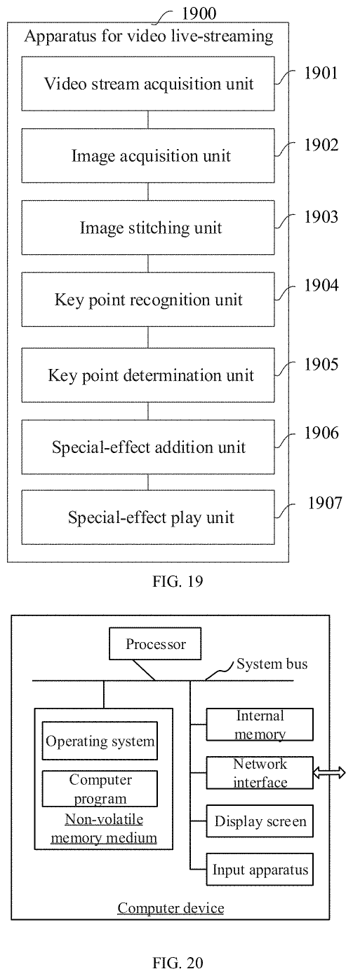

In some embodiments, as shown in FIG. 19, an apparatus for video live-streaming 1900 is provided, and the apparatus includes:

a video stream acquisition unit 1901, configured to acquire a live video stream of a first account, and acquire a live video stream of a second account;

an image acquisition unit 1902, configured to extract a first to-be-recognized image from the live video stream of the first account, and extract a second to-be-recognized image from the live video stream of the second account:

an image stitching unit 1903, configured to stitch the first to-be-recognized image and the second to-be-recognized image to acquire a target image;

a key point recognition unit 1904, configured to input the target image into an image recognition model to acquire a plurality of first key points of the target image;

a key point determination unit 1905, configured to determine, based on the plurality of first key points, second key points of the first to-be-recognized image and the second to-be-recognized image;

a special-effect addition unit 1906, configured to add, based on the second key points of the first to-be-recognized image, image special effects to the first to-be-recognized image to acquire a first special-effect image, and add, based on the second key points of the second to-be-recognized image, image special effects to the second to-be-recognized image to acquire a second special-effect image; and

a special-effect play unit 1907, configured to play a special-effect live-streaming video of the first account and a special-effect live-streaming video of the second account, wherein the special-effect live-streaming video of the first account includes the first special-effect image, and the special-effect live-streaming video of the second account includes the second special-effect image.

For the definitions of the apparatus for recognizing images and the apparatus for video live-streaming, please refer to the above definitions of the method for recognizing images and the method for video live-streaming in the above, which will not be repeated herein. The modules in the above apparatus for recognizing images and the apparatus for video live-streaming may be implemented in whole or in part by software, hardware, and combinations thereof. The above modules may be embedded in or independent of a processor in a computer device in the form of hardware, and may also be stored in a memory in the computer device in the form of software, such that the processor calls and executes the operations corresponding to the above modules.

The apparatus for recognizing images and apparatus for video live-streaming above may be configured to execute the method for recognizing images and method for video live-streaming according to any of the above embodiments, and have corresponding functions and beneficial effects.

An embodiment of the present disclosure shows a computer device, and the computer device includes: a processor; and

a memory for storing one or more instructions executable by the processor;

wherein the processor, when loading and executing the one or more instructions, is caused to perform the above method for recognizing images.

An embodiment of the present disclosure shows a computer device, and the computer device includes:

a processor; and

a memory for storing one or more instructions executable by the processor;

wherein the processor, when loading and executing the one or more instructions, is caused to perform the above method for video live-streaming.

FIG. 20 is a computer device shown in an embodiment of the present disclosure, the computer device is provided as a terminal, and an internal structural diagram thereof is as shown in FIG. 20. The computer device includes a processor, a memory, a network interface, a display screen, and an input apparatus which are connected by a system bus. The processor of the computer device is configured to provide computing and control capabilities. The memory of the computer device includes a non-transitory storage medium and an internal memory. The non-transitory storage medium stores an operating system and a computer program. The internal memory provides an environment for operation of the operating system and computer program in the non-transitory storage medium. The network interface of the computer device is configured to communicate with an external terminal through network connection. In the case that the computer program is executed by the processor, the method for recognizing images and method for video live-streaming are implemented. The display screen of the computer device is a liquid crystal display screen or an electronic ink display screen, and the input apparatus of the computer device is a touch layer covering the display screen, or a button, a trackball or a touchpad disposed on a shell of the computer device, or an external keyboard, touchpad, or mouse, etc.

Those skilled in the art can understand that the structure shown in FIG. 20 is only a block diagram of a partial structure related to the solution of the present disclosure, and does not form a limitation to the computer device to which the solution of the present disclosure is applied. The computer device includes more or fewer components than those shown in the figures, or combines certain components, or has different arrangement of components.

The present disclosure also provides a computer program product, including a computer program cod. In response to a computer running the computer program code, the computer is enabled to perform the above method for recognizing images and method for video live-streaming.

Those of ordinary skill in the art can understand that all or part of the steps in the methods of the above embodiments are completed by instructing relevant hardware through a computer program, the computer program may be stored in a non-transitory computer-readable storage medium, and the computer program, when executed, may include the steps of the above each embodiment of the method. Any reference to a memory, storage, a database or other mediums used in the embodiments according to the present disclosure may include a non-transitory anchor transitory memory. The non-transitory memory may include a read only memory (ROM), a, programmable ROM (PROM), an electrically programmable ROM (EPROM), an electrically erasable programmable ROM (EEPROM), or a flash memory. The transitory memory may include a random-access memory (RAM) or external cache memory. By way of illustration instead of limitation, the RAM is available in various forms such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a memory bus (Rambus) direct RAM (RDRAM), a direct memory bus dynamic RAM (DRDRAM), a memory bus dynamic RAM (RDRAM) and so on.

Other embodiments of the present disclosure are easily conceivable fix those skilled in the art upon consideration of the description and practice of the present disclosure disclosed herein. The present disclosure is intended to cover any variations, uses, or adaptive changes of the present disclosure, and these variations, uses, or adaptive changes that follow general principles of the present disclosure and include common general knowledge or conventional technical means in the art not disclosed by the present disclosure. The description and embodiments are regarded as exemplary only, with the true scope and spirit of the present disclosure being indicated by the following claims.

It is to be understood that the present disclosure is not limited to the precise structures described above and illustrated in the accompanying drawings, and various modifications and changes can be made without departing from the scope. The scope of the present disclosure is limited only by the appended claims.

Those of ordinary skill in the art can understand that all or part of the steps in the methods of the above embodiments are realized by instructing relevant hardware through a computer program, the computer program may be stored in a non-transitory computer-readable storage medium, and the computer program, when executed, may include the steps of the above embodiments of the methods. Any reference to a memory, storage, a database or other mediums used in the embodiments according to the present disclosure may include a non-transitory and/or transitory memory. The non-transitory memory may include a read only memory (ROM), a programmable ROM (PROM), an electrically programmable ROM (EPROM), an electrically erasable programmable ROM (EEPROM), or a flash memory. The transitory memory may include a random-access memory (RAM) or external cache memory. By way of illustration without limitation, the RAM is available in various forms such as a static RAM (SRAM), a dynamic RAM (DRAM), a synchronous DRAM (SDRAM), a double-data rate SDRAM (DDRSDRAM), an enhanced SDRAM (ESDRAM), a synchronous link (Synchlink) DRAM (SLDRAM), a memory bus (Rambus) direct RAM (RDRAM), a direct memory bus dynamic RAM (DRDRAM), memory bus dynamic RAM (RDRAM) and so on.

Various technical features of the above embodiments may be combined freely. For the briefness of description, not all possible combinations of the various technical features in the above embodiments are described. However, as long as there is no contradiction in the combinations of these technical features, they should be considered to be within the scope of the description.

What is claimed is:

1. A method for recognizing images, applicable to a computer device, the method comprising:
acquiring a plurality of to-be-recognized images;
acquiring a target image by stitching the plurality of to-be-recognized images;
acquiring a plurality of first key points of the target image by inputting the target image into an image recognition model; and
determining, based on the plurality of first key points, second key points of each of the to-be-recognized images.

2. The method according to claim 1, wherein pixel coordinates of the first key point on the target image are first key point coordinates, and said determining, based on the plurality of first key points, second key points of each of the to-be-recognized images comprises:
determining coordinate conversion parameters corresponding to the first key point coordinates, wherein the coordinate conversion parameters are configured to convert the first key point coordinates into coordinates of the second key point on the to-be-recognized image;
converting, based on the coordinate conversion parameters corresponding to the first key point coordinates, the first key point coordinates into second key point coordinates; and
determining a pixel point in the to-be-recognized image at the second key point coordinates as the second key point.

3. The method according to claim 2, wherein the target image comprises a plurality of image regions, the plurality of image regions containing to-be-recognized images corresponding to the plurality of image regions; and said determining the coordinate conversion parameters corresponding to the first key point coordinates comprises:
determining, in the plurality of image regions, a target image region corresponding to the first key point coordinates; and
determining, based on the to-be-recognized image corresponding to the target image region, the coordinate conversion parameters corresponding to the first key point coordinates.

4. The method according to claim 3, further comprising:
determining, based on pixel coordinates of pixel points in the to-be-recognized image, an image boundary of the to-be-recognized image;
acquiring image region division coordinates by determining the pixel coordinates of the image boundary of the to-be-recognized image on the target image; and
dividing, based on the image region division coordinates, the target image into the plurality of image regions.

5. The method according to claim 2, wherein said determining the coordinate conversion parameters corresponding to the first key point coordinates comprises:
determining at least one pixel point in the to-be-recognized image as a reference pixel point;
acquiring pre-stitching reference pixel coordinates by determining pixel coordinates of the reference pixel point on the to-be-recognized image, and acquiring post-stitching reference pixel coordinates by determining pixel coordinates of the reference pixel point on the target image; and
determining, based on the post-stitching reference pixel coordinates and the pre-stitching reference pixel coordinates, the coordinate conversion parameters.

6. The method according to claim 5, wherein said determining, based on the post-stitching reference pixel coordinates and the pre-stitching reference pixel coordinates, the coordinate conversion parameters comprise:
determining difference values between the post-stitching reference pixel coordinates and the pre-stitching reference pixel coordinates as the coordinate conversion parameters; or
determining difference values between the pre-stitching reference pixel coordinates and the post-stitching reference pixel coordinates as the coordinate conversion parameters.

7. The method according to claim 6, wherein said converting, based on the coordinate conversion parameters corresponding to the first key point coordinates, the first key point coordinates into the second key point coordinates comprises:
determining, in response to the coordinate conversion parameters being the difference values between the post-stitching reference pixel coordinates and the pre-stitching reference pixel coordinates, difference values between the first key point coordinates and the coordinate conversion parameters as the second key point coordinates; and
determining, in response to the coordinate conversion parameters being the difference values between the pre-stitching reference pixel coordinates and the post-stitching reference pixel coordinates, sums of the first key point coordinates and the coordinate conversion parameters as the second key point coordinates.

8. The method according to claim 1, wherein said acquiring the target image by stitching the plurality of to-be-recognized images comprises:
acquiring a plurality of images of an equal size by scaling at least one to-be-processed image of the plurality of to-be-recognized images; and
acquiring the target image by stitching the plurality of images of the equal size.

9. A method for live-streaming videos, applicable to a computer device, the method comprising:
acquiring a live video stream of a first account and a live video stream of a second account;
extracting a first to-be-recognized image from the live video stream of the first account and a second to-be-recognized image from the live video stream of the second account;
acquiring a target image by stitching the first to-be-recognized image and the second to-be-recognized image;
acquiring a plurality of first key points of the target image by inputting the target image into an image recognition model;
determining, based on the plurality of first key points, second key points of the first to-be-recognized image and the second to-be-recognized image;
acquiring a first special-effect image by adding, based on the second key points of the first to-be-recognized image, image special effects to the first to-be-recognized image, and acquiring a second special-effect image by adding, based on the second key points of the second to-be-recognized image, image special effects to the second to-be-recognized image; and
playing a special-effect live-streaming video of the first account and a special-effect live-streaming video of the second account, wherein the special-effect live-streaming video of the first account comprises the first special-effect image, and the special-effect live-streaming of the second account comprises the second special-effect image.

10. A computer device, comprising:
a processor; and
a memory for storing one or more instructions executable by the processor;
wherein the processor, when loading and executing the one or more instructions, is caused to perform:
acquiring a plurality of to-be-recognized images;
acquiring a target image by stitching the plurality of to-be-recognized images;
acquiring a plurality of first key points of the target image by inputting the target image into an image recognition model; and
determining, based on the plurality of first key points, second key points of each of the to-be-recognized images.

11. The computer device according to claim 10, wherein pixel coordinates of the first key point on the target image are first key point coordinates; and the processor, when loading and executing the one or more instructions, is caused to perform:
determining coordinate conversion parameters corresponding to the first key point coordinates, wherein the coordinate conversion parameters are configured to convert the first key point coordinates into coordinates of the second key point on the to-be-recognized image;
converting, based on the coordinate conversion parameters corresponding to the first key point coordinates, the first key point coordinates into second key point coordinates; and
determining a pixel point in the to-be-recognized image at the second key point coordinates as the second key point.

12. The computer device according to claim 11, wherein the target image comprises a plurality of image regions, the plurality of image regions containing to-be-recognized images corresponding to the plurality of image regions; and the processor, when loading and executing the one or more instructions, is caused to perform:
determining, in the plurality of image regions, a target image region corresponding to the first key point coordinates; and
determining, based on the to-be-recognized image corresponding to the target image region, the coordinate conversion parameters corresponding to the first key point coordinates.

13. The computer device according to claim 12, wherein the processor, when loading and executing the one or more instructions, is caused to perform:
determining, based on pixel coordinates of pixel points in the to-be-recognized image, an image boundary of the to-be-recognized image;
acquiring image region division coordinates by determining the pixel coordinates of the image boundary of the to-be-recognized image on the target image; and
dividing, based on the image region division coordinates, the target image into the plurality of image regions.

14. The computer device according to claim 11, wherein the processor, when loading and executing the one or more instructions, is caused to perform:
determining at least one pixel point in the to-be-recognized image as a reference pixel point;
acquiring pre-stitching reference pixel coordinates by determining pixel coordinates of the reference pixel point on the to-be-recognized image, and acquiring post-stitching reference pixel coordinates by determining pixel coordinates of the reference pixel point on the target image; and
determining, based on the post-stitching reference pixel coordinates and the pre-stitching reference pixel coordinates, the coordinate conversion parameters.

15. The computer device according to claim 14, wherein the processor, when loading and executing the one or more instructions, is caused to perform:
determining difference values between the post-stitching reference pixel coordinates and the pre-stitching reference pixel coordinates as the coordinate conversion parameters; or,
determining difference values between the pre-stitching reference pixel coordinates and the post-stitching reference pixel coordinates as the coordinate conversion parameters.

16. The computer device according to claim 15, wherein the processor, when loading and executing the one or more instructions, is caused to perform:
determining, in response to the coordinate conversion parameters being the difference values between the post-stitching reference pixel coordinates and the pre-stitching reference pixel coordinates, difference values between the first key point coordinates and the coordinate conversion parameters as the second key point coordinates; and
determining, in response to the coordinate conversion parameters being the difference values between the pre-stitching reference pixel coordinates and the post-stitching reference pixel coordinates, sums of the first key point coordinates and the coordinate conversion parameters as the second key point coordinates.

17. The computer device according to claim 10, wherein the processor, when loading and executing the one or more instructions, is caused to perform:
acquiring a plurality of images of an equal size by scaling at least one to-be-processed image of the plurality of to-be-recognized images; and
acquiring the target image by stitching the plurality of images of the equal size.
